(19) United States
(12) Patent Application Publication
(10) Pub. No.: US 2026/0210785 A1
(43) Pub. Date: Jul. 23, 2026

(54) VENTING PRESSURE MEASURING APPARATUS AND METHOD

(71) Applicant: LG ENERGY SOLUTION, LTD., Seoul (KR)

(72) Inventors: Yoon-Oh KO, Daejeon (KR); Jin-Ju PARK, Daejeon (KR); Dae-Han BAE, Daejeon (KR)

(73) Assignee: LG ENERGY SOLUTION, LTD., Seoul (KR)

(21) Appl. No.: 19/455,215

(22) Filed: Jan. 21, 2026

(30) Foreign Application Priority Data
Jan. 22, 2025 (KR) 10-2025-0009739

(51) Int. Cl. G01L 19/04; H01M 10/42

(52) U.S. Cl. CPC G01L 19/04; H01M 10/4285

(57) ABSTRACT

A venting pressure measuring apparatus measures pressure at which a venting cover of a battery module ruptures, and includes: a pressure jig that allows the venting cover to be placed and supported thereon, and is provided with a pressure space formed to apply pressure to the venting cover; and a top jig that presses the venting cover into close contact with the pressure jig, and is provided with a through hole formed at a position corresponding to the pressure space. A gas flow when venting occurs in the battery module is simulated by shapes of the pressure space and the through hole.

### CROSS REFERENCES TO RELATED APPLICATIONS

This application is based on and claims priority from Korean Patent Application No. 10-2025-0009739, filed on Jan. 22, 2025, with the Korean Intellectual Property Office, the disclosure of which is incorporated herein in its entirety by reference.

### TECHNICAL FIELD

The present disclosure relates to an apparatus and method for measuring a venting pressure of a battery module.

### BACKGROUND

As the demand for portable electronic devices such as smartphones, tablet PCs, and smartwatches greatly increases, and electric vehicles are increasingly adopted, research on batteries mounted therein, especially, rechargeable secondary batteries is being actively conducted.

Currently, commercially available secondary batteries include, for example, nickel-cadmium batteries, nickel-hydrogen batteries, nickel-zinc batteries, and lithium secondary batteries. Of these secondary batteries, lithium secondary batteries are gaining considerable attention due to their advantages including a substantially low memory effect to allow a high degree of freedom in charging and discharging, a very low self-discharging rate, and a high energy density, as compared to the nickel-based secondary batteries.

Lithium secondary batteries mainly use lithium-based oxides and carbon materials as the positive electrode active material and the negative electrode active material, respectively. Further, a lithium secondary battery includes an electrode assembly in which a positive electrode plate and a negative electrode plate coated with the positive electrode active material and the negative electrode active material, respectively, are disposed with a separator interposed therebetween, and includes an outer casing for hermetically accommodating the electrode assembly together with an electrolyte, such as, for example, a battery case.

In general, according to the shape of the outer casings, lithium secondary batteries may be classified into various types including can-type secondary batteries, in which the electrode assembly is mounted in a metal can, and pouch-type secondary batteries, in which the electrode assembly is mounted in a pouch of an aluminum laminate sheet.

Recently, secondary batteries are widely used not only in small-sized devices such as portable electronic devices, but also in medium-to-large-sized devices such as electric vehicles and energy storage systems (ESS), for powering or energy storage purposes.

In line with these changes in demand, large-capacity secondary batteries are being developed, and with this, interest in the safety issue of secondary batteries is increasing.

### SUMMARY

The present disclosure provides a venting pressure measuring apparatus and method that measure, through an actual test, the pressure when a venting cover ruptures reflecting the conditions of a thermal runaway situation, thereby measuring the rupture pressure close to the rupture pressure in an actual situation.

According to an aspect of the present disclosure, a venting pressure measuring apparatus measures pressure at which a venting cover of a battery module ruptures, and the apparatus includes: a pressure jig that allows the venting cover to be placed and supported thereon, and is provided with a pressure space formed to apply pressure to the venting cover; and a top jig that presses the venting cover into close contact with the pressure jig, and is provided with a through hole formed at a position corresponding to the pressure space, wherein a gas flow when venting occurs in the battery module is simulated by the shapes of the pressure space and the through hole.

The venting pressure measuring apparatus according to an embodiment of the present disclosure may further include: a heater that heats the venting cover.

The heating unit may include a heat generation member that is embedded in the pressure jig.

The pressure applied to the venting cover may be formed by gas supplied to the pressure space, and the heating unit may be configured to heat the gas supplied to the pressure space.

The pressure space may be formed in a shape corresponding to a shape of the through hole.

A plurality of pressure spaces may be provided in the pressure jig, and a plurality of through holes may be provided in the top jig at positions corresponding to the plurality of pressure spaces.

At least a portion of the plurality of through holes may be formed to be different from remaining through holes in at least one of a size and a shape.

The venting pressure measuring apparatus according to an embodiment of the present disclosure may further include: a pressure generation unit that applies pressure to the plurality of pressure spaces, wherein different pressures are applied to the plurality of pressure spaces according to at least two or more respective portions.

The venting pressure measuring apparatus according to an embodiment of the present disclosure may further include: a control unit that measures the pressure when the venting cover ruptures due to the pressure applied by the pressure space.

The control unit may include a pressure sensor that measures pressure in the pressure space, and may determine a time point when the venting cover ruptures, based on data of the pressure measured by the pressure sensor.

The control unit may measure the pressure when the venting cover ruptures, twice, and a size of the through hole in a first measurement and a size of the through hole in a second measurement may be different from each other.

According to another aspect of the present disclosure, a venting pressure measuring method measures a venting pressure of a venting cover used as a component of a battery module, and includes: a placing step of placing the venting cover in a pressure jig provided with a pressure space; a fixing step of pressing the venting cover using a top jig provided with a through hole formed at a position corresponding to the pressure space, thereby bringing the venting cover into close contact with the pressure jig; and a pressure applying step of applying pressure to the venting cover through the pressure space.

The placing step, the fixing step, and the pressure applying step may be sequentially repeated twice, and two fixing steps may be performed using top jigs different from each other in at least one of a size a nd a shape of the through hole.

Of the two fixing steps, one fixing step may be performed using a top jig provided with a through hole larger than the pressure space, and a remaining fixing step may be performed using a top jig provided with a through hole equal to or smaller than the pressure space.

A separation line, which is configured to easily rupture, may be formed in one surface of the venting cover, the one fixing step may be performed in a state where the surface in which the separation line is formed is disposed to face the through hole, and the remaining fixing step may be performed in a state where the surface in which the separation line is formed is disposed to face the pressure space.

A venting hole may be provided in the battery module to discharge a venting gas, and the through hole may be formed in a shape corresponding to a shape of the venting hole.

A plurality of pressure spaces may be provided in the pressure jig, a plurality of through holes may be provided in the top jig at positions corresponding to the plurality of pressure spaces, and at least a portion of the plurality of through holes may be formed to be different from remaining through holes in at least one of a size and a shape.

The pressure applied to at least a portion of the plurality of pressure spaces may be controlled differently from the pressure applied to the remaining pressure spaces.

The venting pressure measuring method according to an embodiment of the present disclosure may further include: a heating step of heating the venting cover, wherein the heating step is performed prior to or simultaneously with the pressure applying step.

According to the present disclosure, the pressure at which the venting cover ruptures, that is, the venting pressure, may be accurately measured.

For example, the venting pressure is measured by simulating the venting behavior of a gas generated in the thermal runaway event, so that the venting pressure may be measured under similar conditions to those in an actual battery module.

Further, the venting pressure in both a thermal runaway situation and a thermal runaway propagation situation may be measured, so that a battery module may be more stably designed.

According to an embodiment of the present disclosure, the venting pressure in both the thermal runaway situation and the thermal runaway propagation situation may be measured through a single measurement process.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a schematic exploded perspective view illustrating a configuration of a battery module.

FIG. 2 is an exploded perspective view of a module case and a top cover that have another structure.

FIG. 3 is a view illustrating a schematic configuration of a venting pressure measuring apparatus according to an embodiment of the present disclosure.

FIG. 4 is an exploded perspective view illustrating some components of the venting pressure measuring apparatus according to an embodiment of the present disclosure.

FIG. 5 is a sectional view illustrating a state where a venting cover is mounted in the venting pressure measuring apparatus according to an embodiment of the present disclosure.

FIG. 6 is a schematic sectional view illustrating a pressure jig according to another embodiment of the present disclosure.

FIG. 7 is a plan view of the pressure jig illustrated in FIG. 6 when viewed from top to bottom (Z-axis direction).

FIG. 8 is a sectional view illustrating a portion of the configuration of a battery module, to depict a thermal runaway situation occurring in the battery module.

FIG. 9 is a schematic perspective view illustrating a pressure jig and a top jig according to yet another embodiment of the present disclosure.

FIG. 10 is a sectional view schematically illustrating two situations in which a venting cover of a battery module ruptures.

FIG. 11 is a block diagram illustrating a hardware configuration for implementing a control unit included in a venting pressure measuring apparatus according to an embodiment of the present disclosure.

FIG. 12 is a schematic flowchart illustrating a venting pressure measuring method according to an embodiment of the present disclosure.

FIG. 13 is a schematic flowchart illustrating a venting pressure measuring method according to another embodiment of the present disclosure.

In some of the accompanying drawings, corresponding components will be denoted with the same reference numerals. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Hereinafter, embodiments of the present disclosure will be described in detail with reference to the accompanying drawings. Words and terms used in the detailed description and the claims herein should not be interpreted to be limited to their usual or dictionary meanings, but should be interpreted to have meanings and concepts that correspond to the technical idea of the present disclosure in compliance with the principle that inventors may appropriately define terms and concepts for the purpose of best describing the present disclosure.

Accordingly, it can be appreciated that the embodiments described herein and the configurations illustrated in the drawings are merely the most preferable embodiments of the present disclosure, which do not exhaustively represent the technical idea of the present disclosure, and various equivalents and modifications may be made to substitute the present disclosure at the time of filing the present disclosure.

In the descriptions herein, expressions indicating directions such as “up,” “down,” “left,” “right,” “front,” and “rear” may be used. It is obvious to those skilled in the art that the expressions are used only to facilitate the description, and may vary depending on, for example, the location of a target object or an observer.

In the descriptions herein, terms indicating directions such as inner and outer may be used, and unless otherwise specified, “inner” refers to a direction toward the center of a battery module, and “outer” refers to the opposite direction.

In the descriptions herein, various embodiments are included, and each embodiment will be described focusing on differences from the other embodiments by omitting detailed descriptions of identical or similar parts to those of the other embodiments.

Multiple secondary batteries may form a single battery module by being accommodated all together in a module case in the state of being electrically connected to each other. Here, each secondary battery included in the single battery module may be referred to as a battery cell. Multiple battery modules may be connected to form a single battery pack.

A battery module may include, for example, a case, a plurality of battery cells accommodated in the case, and a bus bar assembly for electrically connecting the plurality of battery cells. When events such as thermal runaway occur in the battery module configured as described above, it is important to prevent the thermal runaway from being propagated to adjacent battery cells or modules.

To this end, a venting cover is provided on one side of the case to effectively discharge a high-temperature high-pressure gas generated during the thermal runaway in the battery cells to the outside. For example, separation lines are formed in the venting cover such that portions where the separation lines are formed may more easily rupture in the thermal runaway event than the other portions, and the high-temperature high-pressure gas may be discharged to the outside by rupturing the portions where the separation lines are formed.

In order to design a stable battery module or battery pack, it is necessary to accurately identify the pressure at which the venting cover ruptures. In the related art, the pressure at which the venting cover ruptures is predicted based on specifications of the venting cover, for example, data such as physical properties of a material (e.g., strength, tensile strength, an elongation rate, and heat resistance) and thickness, and the prediction result is reflected in the design of a battery module. The related art merely uses measured data without sufficiently reflecting geometrical structures of actual battery modules (or battery packs) or various conditions occurring in the thermal runaway event.

The methods of related art have limitations in accurately measuring the pressure at which the venting cover actually ruptures. In consideration of the problem, the present disclosure provides an apparatus and a method capable of accurately measuring the pressure at which the venting cover ruptures.

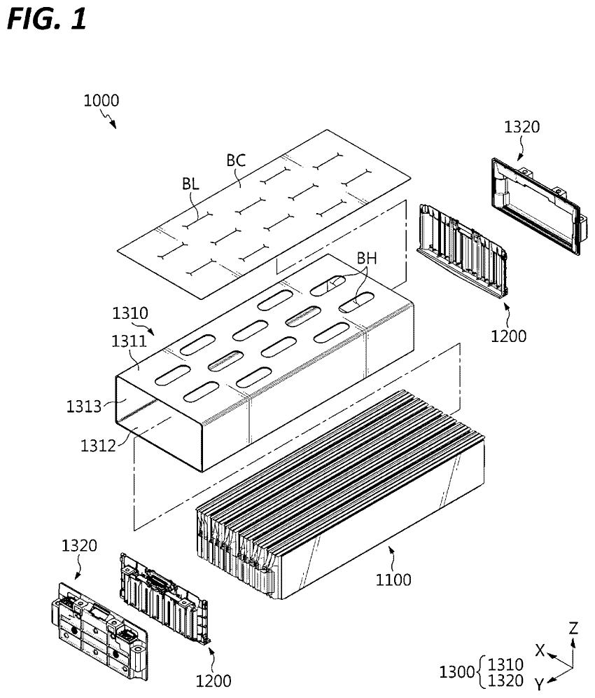

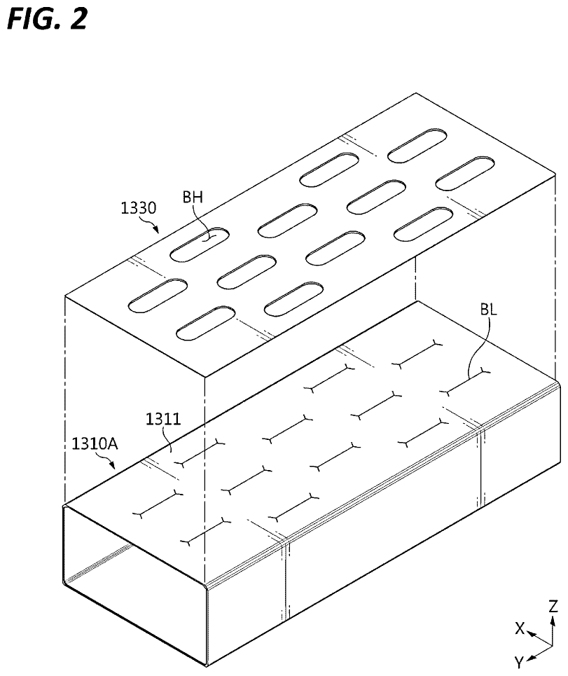

The venting pressure measuring apparatus according to an embodiment of the present disclosure may be an apparatus for measuring the pressure at which the venting cover of a battery module ruptures. First, the battery module and the venting cover will be described. FIG. 1 is a schematic exploded perspective view illustrating the configuration of a battery module. FIG. 2 is an exploded perspective view of a module case and a top cover that have another structure.

Referring to FIG. 1, a battery module 1000 according to an embodiment of the present disclosure may include a plurality of battery cells 1100, a bus bar assembly 1200 that electrically connects the plurality of battery cells 1100, a module case 1300, and a venting cover BC.

Of the components above, the module case 1300 may be configured to form a cavity therein for accommodating the plurality of battery cells 1100 and the bus bar assembly 1200. For example, the module case 1300 may include a main body frame 1310 and end frames 1320 that cover openings at both ends of the main body frame 1310. The main body frame 1310 may include an upper plate 1311, a lower plate 1312, and side plates 1313. A plurality of venting holes BH may be formed in the upper plate 1311.

The venting cover BC may be disposed between the plurality of battery cells 1100 and the upper plate 1311 of the main body frame 1310. For example, the venting cover BC may be coupled to the lower surface of the upper plate 1311 of the main body frame 1310. The venting cover BC may be made of a flame-resistant material. For example, the venting cover BC may be made of mica or a fiber reinforced board (FRB). A separation line BL may be formed in the venting cover BC. The separation line BL may be formed in the upper surface of the venting cover BC, for example, in the surface of the venting cover BC that faces the upper plate 1311.

The separation line BL may be used as general terms encompassing a perforated line, a notching line, a cutting line, a shredding line, and a tear line. According to an embodiment, a plurality of separation lines BL may be formed at positions corresponding to the venting holes BH. The separation line BL may be configured to rupture by pressure applied to the venting cover BC, for example, a high-pressure gas generated when thermal runaway occurs. For example, the separation line BL may be formed by forming a notching line or a cutting line in the venting cover BC.

In the normal state of the battery module 1000, the venting cover BC blocks the venting holes BH, thereby preventing external foreign substances such as moisture or dust from entering the battery module 1000. When thermal runaway occurs in the battery module 1000, the separation line BL of the venting cover BC ruptures, and the venting holes BH may be opened. The pressure when the venting cover BC ruptures may be referred to as a venting pressure. When the separation line BL of the venting cover BC ruptures, flame and gas may be rapidly discharged through the venting holes BH of the main body frame 1310, and thus, the propagation of thermal runaway to adjacent battery modules 1000 may be prevented or suppressed.

Meanwhile, the venting cover BC and the venting holes BH may be implemented in another form. For example, as illustrated in FIG. 2, the separation line BL may be formed in the upper plate 1311 of a main body frame 1310A. A top cover 1330 may be coupled to the upper plate 1311. A plurality of venting holes BH may be formed in the top cover 1330. In this structure, the top cover 1330 may implement the function of the venting cover.

The venting cover may be terms encompassing components that rapidly rupture when thermal runaway occurs, to discharge gas and flame inside the battery module 1000 to the outside.

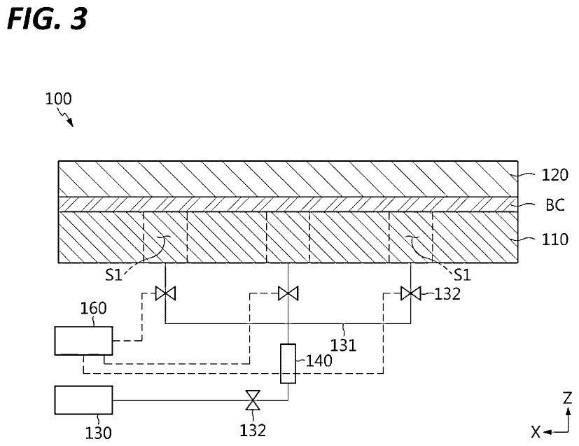

The venting pressure measuring apparatus may be an apparatus that measures the pressure when the venting cover BC described above ruptures. Hereinafter, a venting pressure measuring apparatus 100 according to an embodiment of the present disclosure will be described with reference to FIGS. 3 to 5. In describing the venting pressure measuring apparatus 100, the components of the venting pressure measuring apparatus 100 that match the components or phenomena of the battery module 1000 will also be described.

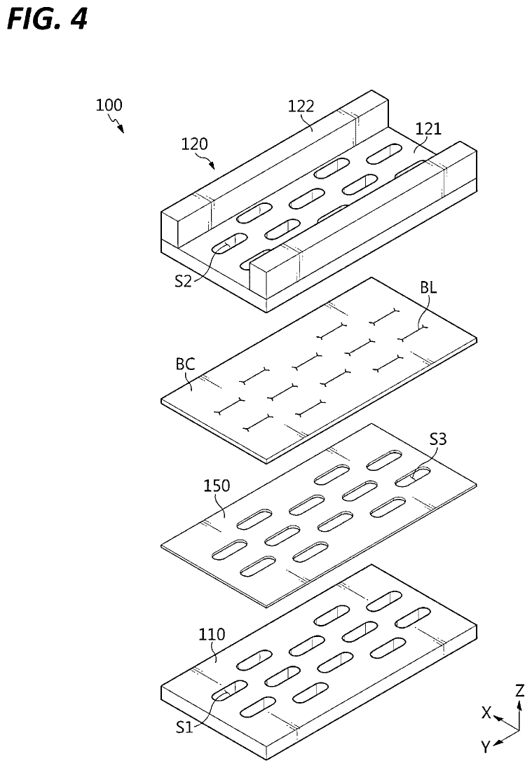

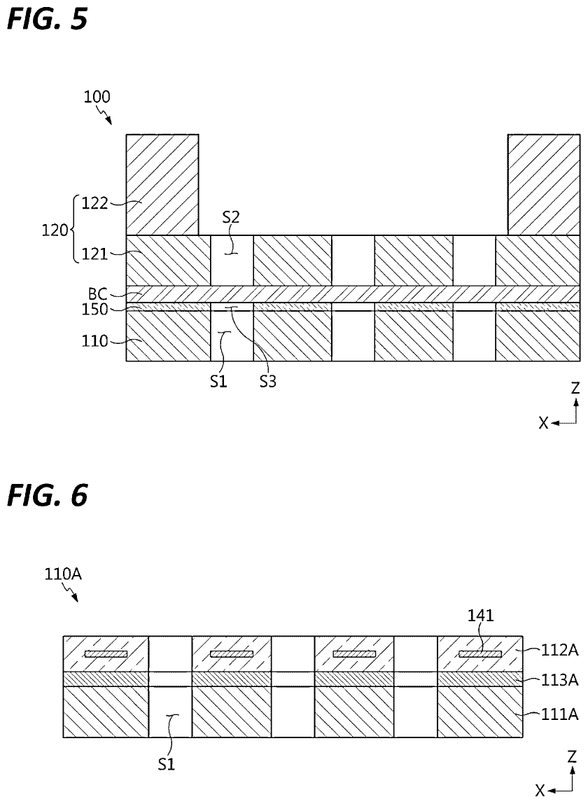

FIG. 3 is a view illustrating the schematic configuration of the venting pressure measuring apparatus according to an embodiment of the present disclosure, and FIG. 4 is an exploded perspective view illustrating some components of the venting pressure measuring apparatus according to an embodiment of the present disclosure. FIG. 5 is a sectional view illustrating the state where the venting cover BC is mounted in the venting pressure measuring apparatus according to an embodiment of the present disclosure.

Referring to FIGS. 3 to 5, the venting pressure measuring apparatus 100 according to the present embodiment may include a pressure jig 110 and a top jig 120. A pressure space S1 may be formed in the pressure jig 110, and a through hole S2 may be formed in the top jig 120. According to an embodiment, the pressure space S1 and the through hole S2 may be configured to simulate a gas flow when venting occurs in the battery module 1000.

The pressure jig 110 may support the venting cover BC. For example, the pressure jig 110 may be formed in a flat plate shape, and the venting cover BC may be placed and supported on the upper surface of the pressure jig 110 (the surface in the Z-axis direction). At this time, the upper surface of the pressure jig 110 may be formed to correspond to the venting cover BC. For example, when the venting cover BC has a rectangular shape, the upper surface of the pressure jig 110 may also be formed in the rectangular shape. As a result, the pressure jig 110 may stably support the venting cover BC.

The pressure space S1 may be formed in the pressure jig 110 to apply pressure to the venting cover BC. For example, the pressure space S1 may be formed in the upper surface of the pressure jig 110. The pressure space S1 may be formed to be recessed downward from the upper surface. According to an embodiment, as illustrated in FIG. 4, the pressure space S1 may be formed to penetrate the upper surface and the lower surface of the pressure jig 110. As illustrated in FIG. 3, the pressure space S1 may be connected to a pressure generator 130. The pressure generator 130 may be a device that forms pressure in a specific space or region. When the pressure generator 130 operates, pressure may be formed in the pressure space S1. Then, the pressure formed in the pressure space S1 may be applied to the venting cover BC.

For example, the venting cover BC may be placed on the upper surface of the pressure jig 110 to block the pressure space S1. At this time, as described above, the separation line BL may be formed in the venting cover BC, and the region where the separation line BL is formed may be disposed above the pressure space S1. Then, the pressure formed in the pressure space S1 may be applied to the venting cover BC. Further, the pressure may be applied to the region where the separation line BL is formed, in the venting cover BC.

The pressure space S1 may match the space where the battery cells 1100 are arranged in the battery module 1000, for example, the internal space of the module case 1300. The two spaces may match each other in that both are spaces where the pressure at which the venting cover BC ruptures is formed.

The top jig 120 may be configured to bring the venting cover BC into close contact with the pressure jig 110. According to an embodiment, the top jig 120 may be disposed above the pressure jig 110, and the venting cover BC may be disposed between the top jig 120 and the pressure jig 110. The top jig 120 presses the venting cover BC downward, and consequently, the venting cover BC may come into close contact with the pressure jig 110. The through hole S2 may be provided in the top jig 120. The through hole S2 of the top jig 120 may be formed at the position corresponding to the pressure space S1 of the pressure jig 110. For example, the through hole S2 may be disposed above the pressure space S1 to face the pressure space S1.

The top jig 120 may match the upper plate 1311 in FIG. 1 or the top cover 1330 in FIG. 2. The two components may match each other in that, when high pressure is applied to the venting cover BC, both press the venting cover BC such that the venting cover BC is not pushed due to the high pressure and is secured. The through hole S2 of the top jig 120 may match the venting hole BH of the battery module 1000.

In the venting pressure measuring apparatus 100 configured as described above, the venting cover BC may be disposed on the upper surface of the pressure jig 110, and then, the venting cover BC may be pressed into close contact with and fixed to the pressure jig 110 by using the top jig 120. In this state, when the pressure of the pressure space S1 is increased, the pressure may be applied to the venting cover BC. When the pressure applied to the venting cover BC increases and exceeds a specific threshold, the venting cover BC may rupture. The pressure at this time may be referred to as a “venting pressure,” for example, the pressure at which venting occurs in the battery module 1000.

According to the configuration of the embodiment above, the venting pressure measuring apparatus 100 may measure the pressure at which the venting cover BC ruptures, for example, the venting pressure, while actually applying pressure to the venting cover BC. Therefore, the venting pressure may be more accurately and rapidly measured. In the related art, the venting pressure is calculated solely based on specifications of the venting cover BC itself without considering the conditions when the venting cover BC ruptures, for example, the coupling structure of the venting cover BC in the battery module 1000, and therefore, there is a limitation in terms of accuracy.

In the configuration of the present embodiment, the coupling structure of the venting cover BC in the battery module 1000 is reflected by being matched with the configuration of the venting pressure measuring apparatus 100, for example, the pressure space S1 of the pressure jig 110 and the through hole S2 of the top jig 120, so that the flow of gas vented in the actual battery module 1000 (hereinafter, referred to as a “venting gas behavior”) may be simulated. Therefore, the venting pressure of the venting cover in the battery module 1000 may be accurately measured. Embodiments for simulating the venting gas behavior will be further described below.

The venting pressure measuring apparatus 100 according to an embodiment of the present disclosure may further include a heating unit 140. The heating unit 140 may heat the venting cover BC. For example, the heating unit 140 may be provided around the venting cover BC, and may heat the venting cover BC disposed on the pressure jig 110.

When thermal runaway occurs in the battery module 1000, the venting cover BC may be in the state of being heated to a high temperature. The heating unit 140 is provided to measure the venting pressure of the venting cover BC in the thermal runaway event, and thus, more accurate measurement results may be obtained when tests are performed under identical or similar conditions to those in the thermal runaway event.

According to the configuration of the embodiment above, by applying pressure after (or while) heating the venting cover BC using the heating unit 140, the venting pressure of the venting cover BC under the similar condition to that in the thermal runaway event, that is, in the state of being heated to a high temperature may be measured. Therefore, the venting pressure may be more accurately measured.

The heating unit 140 may be configured to heat gas supplied to the pressure space S1 of the pressure jig 110. For example, gas, for example, air is supplied from the pressure generator 130 to the pressure space S1 of the pressure jig 110, and the air may be compressed in the pressure space S1 so that pressure may be formed. Then, the formed pressure may be applied to the venting cover BC.

At this time, the heating unit 140 may heat the air supplied to the pressure space S1. For example, as illustrated in FIG. 3, the heating unit 140 may be provided in a connection pipe 131 through which the air flows from the pressure generator 130 to the pressure space S1. The heating unit 140 may heat the air flowing through the connection pipe 131.

According to the configuration of the embodiment above, pressure may be applied to the venting cover BC using the air heated to a high temperature, which may be identical to the situation where the venting cover BC ruptures due to the high-temperature high-pressure gas in the battery module 1000, for example, a venting occurrence situation. Therefore, the venting pressure may be more accurately measured.

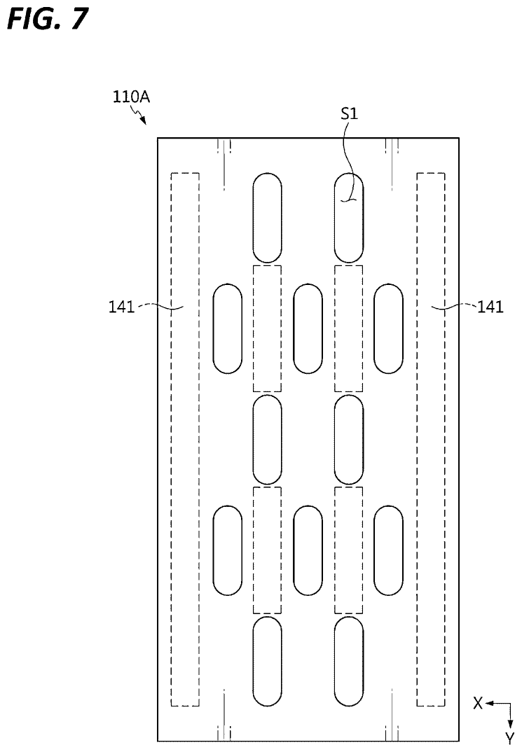

The heating unit 140 may include heat generation members 141. The heat generation members 141 may be embedded in the pressure jig 110. Descriptions will be continued referring to FIGS. 6 and 7. FIG. 6 is a schematic sectional view illustrating a pressure jig 110A according to another embodiment of the present disclosure. FIG. 7 is a plan view of the pressure jig 110 illustrated in FIG. 5 when viewed from top to bottom (in the Z-axis direction).

Referring to FIG. 6, the heat generation members 141 may be embedded in the pressure jig 110A. The pressure jig 110A may be formed in a flat plate shape, and the pressure space S1 may be provided therein. The heat generation members 141 may be embedded in the upper portion of the pressure jig 110A. The heat generation members 141 generate heat when power is applied, and may be implemented in the form of, for example, a nichrome wire. The nichrome wire may heat the venting cover BC to high temperatures. Further, the nichrome wire may exhibit a fast response speed, for example, may rapidly increase or decrease temperatures, and as a result, the temperature of the venting cover may be rapidly controlled.

According to an embodiment, the pressure jig 110A may have a three-layer structure. For example, the pressure jig 110A may include a support plate 111A, a heat generation plate 112A, and a thermal insulation plate 113A. The support plate 111A may be formed in a plate shape, and may be made of a material having high rigidity such as metal. The heat generation plate 112A may be formed in a shape corresponding to the support plate 111A. The heat generation plate 112A may be coupled to the upper side of the support plate 111A. The heat generation members 141 may be embedded in the heat generation plate 112A. The heat generation plate 112A may be made of a material with excellent thermal conductivity such as aluminum. The thermal insulation plate 113A may be disposed between the support plate 111A and the heat generation plate 112A. The thermal insulation plate 113A may be made of a material with an excellent thermal insulation property such as ceramic. The pressure space S1 described above may be formed to penetrate the support plate 111A, the thermal insulation plate 113A, and the heat generation plate 112A.

According to an embodiment, the support plate 111A, the thermal insulation plate 113A, and the heat generation plate 112A may be detachably coupled to each other. In this case, there may be an advantage in that when any one of the plates is damaged, only the damaged plate may be replaced. However, the present disclosure is not limited thereto, and the support plate, the thermal insulation plate, and the heat generation plate may be modularized to be integrally formed as a single unit.

According to the configuration of the embodiment above, the venting cover BC may be heated rapidly. Further, the heating temperature of the venting cover BC may be accurately and easily controlled.

Meanwhile, the temperatures of the heat generation members 141 may be controlled independently for each zone. For example, as illustrated in FIG. 7, the heat generation members 141 may be divided into a plurality of zones according to the regions where the heat generation members 141 is embedded. For example, the heat generation members 141 may be divided into four groups by grouping the heat generation members 141 arranged on the same line along the Y-axis direction into the same group. The temperatures of the heat generation members 141 may be controlled independently for each group, which may be implemented by controlling current supplied to each group.

According to the configuration of the embodiment above, the multiple portions of the venting cover BC may be heated to different temperatures. Therefore, the venting pressure may be measured by changing the heating conditions of the venting cover BC according to various conditions that may occur in the thermal runaway situation (conditions related to temperatures), so that the venting pressure may be more accurately measured.

In the venting pressure measuring apparatus 100, the through hole S2 of the top jig 120 may be formed in a shape corresponding to the shape of the venting hole BH of the battery module 1000. As described above, the top jig 120 may match the upper plate of the module case 1300, and the through hole S2 may match the venting hole BH of the battery module 1000. With the configuration in which the shape of the through hole S2 corresponds to the shape of the vent hole BH, the venting gas behavior in the battery module 1000 may be more accurately simulated. For example, the through hole S2 may be formed in a shape elongated in one direction. A portion of the through hole S2 may have a curved shape, for example, an arc shape. As described herein later, when a plurality of through holes S2 is formed, the plurality of through holes S2 may be arranged to form rows and columns. The reason for forming the through holes S2 in this manner may be that the venting holes BH of the actual battery module 1000 are formed in the same shape and arrangement as described above.

Referring back to FIG. 4, the top jig 120 of the venting pressure measuring apparatus 100 may include a fixing plate 121 and a pressing frame 122. The fixing plate 121 may be formed in a flat plate shape, and may be disposed on the venting cover BC. The through hole S2 may be formed in the fixing plate 121, and as seen from the comparison between FIGS. 1 and 4, the through hole S2 of the venting pressure measuring apparatus 100 may be formed to correspond to the shape of the venting hole BH of the battery module 1000. Here, the “corresponding shape” may indicate that shapes are identical or similar to each other, and sizes thereof may differ to some extent. The fixing plate 121 of the venting pressure measuring apparatus 100 may match the upper plate of the module case 1300 of the battery module 1000, and the through hole S2 may match the venting hole BH.

The pressing frame 122 of the venting pressure measuring apparatus 100 may be disposed on the fixing plate 121. For example, the pressing frame 122 may be coupled to the upper surface of the fixing plate 121, and according to an embodiment, may be detachably coupled thereto. The pressing frame 122 may press the fixing plate 121 downward (e.g., in the-Z-axis direction), for example, toward the pressure jig 110. For example, the structure in which the pressing frame 122 presses the fixing plate 121 may be implemented by, for example, a configuration where a fixing clamp is fastened between the pressing frame 122 and the pressure jig 110. The pressing frame 122 may press the fixing plate 121, and consequently, the fixing plate 121 may come into close contact with and be fixed to the pressure jig 110.

As illustrated in FIG. 4, the pressing frame 122 may be configured to press only both edge portions of the fixing plate 121. As illustrated in FIG. 1, in the battery module 1000, the upper plate (e.g., the component matching the fixing plate) 1311 may have a structure in which only two sides thereof are coupled and fixed to the side plates 1313. In order to simulate this structure, the pressing frame 122 may be configured to press only both edge portions of the fixing plate 121.

According to the embodiment of the configuration described above, it is possible to reflect the structure of the location where venting occurs in the actual battery module 1000, for example, the shape of the venting hole BH and the coupled structure of the upper plate 1311 and the side plates 1313, so that the venting gas behavior may be more accurately simulated.

As described above, the pressure space S1 of the venting pressure measuring apparatus 100 may match the internal space of the module case 1300. Accordingly, when the pressure space S1 is configured to be similar to the internal structure of the module case 1300, more specifically, the structure of the space through which pressure is applied to the venting cover BC, the venting gas behavior may be accurately simulated. However, since various components including the plurality of battery cells 1100 are arranged inside the module case 1300, it may be difficult in practice to simulate the pressure space S1 to be identical to the internal structure of the module case 1300.

According to the present embodiment, in the venting pressure measuring apparatus 100, the shape of the pressure space S1 may be configured to correspond to the shape of the through hole S2 so that, by this configuration, the venting gas behavior may be simulated. For example, the pressure space S1 of the venting pressure measuring apparatus 100 may be formed to correspond to the through hole S2 in shape. Here, the shape of the pressure space S1 may indicate the cross-sectional shape on the plane in which the pressure space S1 and the through hole S2 face each other (e.g., XY plane). The shape of the through hole S2 may also indicate the cross-sectional shape in the XY plane direction.

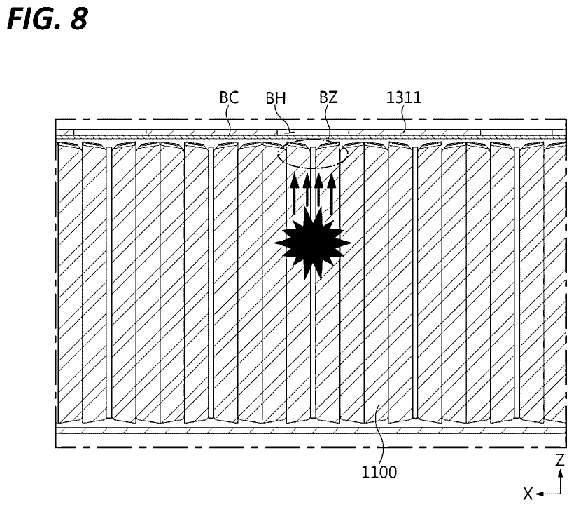

With reference to FIG. 8, descriptions will be made on the reason for simulating the structure of the battery module 1000 as described above, for example, the reason and effects for/from forming the shape of the pressure space S1 of the venting pressure measuring apparatus 100 to correspond to the shape of the through hole S2. FIG. 8 is a sectional view illustrating a portion of the configuration of the battery module 1000 to depict the thermal runaway situation occurring in the battery module 1000.

Referring to FIG. 8, the venting hole BH is formed in the upper plate 1311 of the module case, and the venting cover BC may be coupled to the upper plate 1311. The plurality of battery cells 1100 may be arranged below the venting cover BC. A thermal runaway event may first occur in some of the battery cells 1100 inside the battery module 1000, and gas (and flame) may begin to be released from the battery cells 1100.

At this time, since the battery cells 1100 are stacked with narrow gaps therebetween, the gas may flow, for example, in the vertical direction (e.g., the Z-axis direction) through the gaps between the battery cells 1100. Accordingly, pressure may be concentrated at a specific region of the venting cover BC, for example, the region indicated by BZ in FIG. 8. Although the pressure inside the module case 1300 may increase uniformly as a whole, the interior of the module case 1300 is filled with multiple components including the battery cells 1100, and the pressure of the specific regions in the battery module 1000, for example, the regions indicated by BZ may increase locally as compared to the other regions. Further, since the pressure of the region BZ may increase first, venting may occur first in the region.

In sum, when pressure is applied to the venting cover BC due to the occurrence of thermal runaway, the pressure may be concentrated locally at a narrow region, and initial venting may occur in the region. Accordingly, in the present embodiment, the space through which pressure is applied to the venting cover BC, for example, the pressure space S1 of the venting pressure measuring apparatus 100 may be simulated as the narrow space.

Further, the venting cover BC of the battery module 1000 may be divided into a portion that is supported by the upper plate 1311 and a portion that is not supported by the upper plate 1311. The unsupported portion may indicate the region corresponding to the venting hole BH, and the supported portion may correspond to the remaining region. The portion supported by the upper plate 1311 may have greater strength against the pressure in the Z-axis direction than the unsupported portion. Therefore, when pressure is applied to the venting cover BC, the region corresponding to (facing) the venting hole BH may be most vulnerable to the pressure. Meanwhile, since the separation line BL is formed in the corresponding portion, the portion may be even more vulnerable to the pressure. From another perspective, this may be interpreted as a situation where pressure is concentrated at the corresponding portion, that is, the region corresponding to the venting hole BH.

As described above, it may be understood that the pressure applied to the venting cover BC during the thermal runaway of the battery module 1000 is concentrated at the narrow region, for example, the region facing the venting hole BH. Accordingly, when the pressure space S1 of the venting pressure measuring apparatus 100 is formed in the shape corresponding to the through hole S2 (e.g., the component matching the venting hole BH), the venting gas behavior may be more accurately simulated.

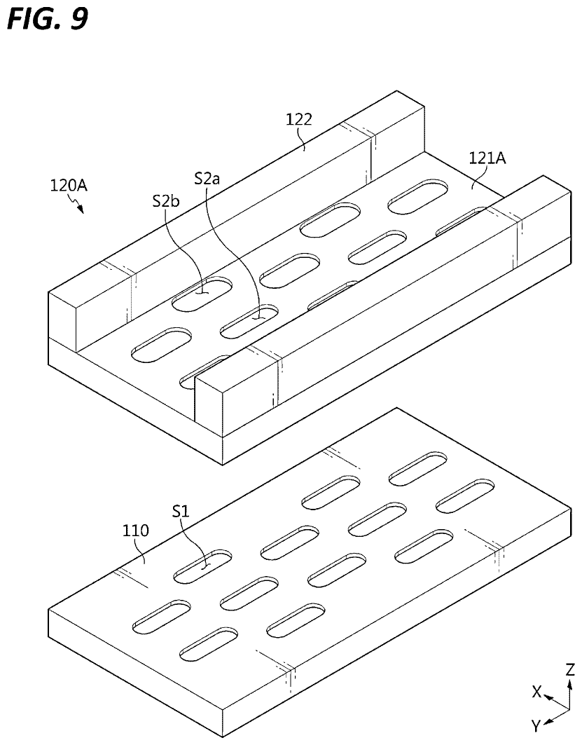

FIG. 9 is a schematic perspective view illustrating a portion of the configuration of the venting pressure measuring apparatus 100 according to another embodiment of the present disclosure.

Referring to FIG. 9, a plurality of pressure spaces S1 and a plurality of through holes S2 may be provided. The plurality of through holes S2 may be formed at positions corresponding to the pressure spaces S1. For example, the plurality of pressure spaces S1 may be provided in the pressure jig 110. For example, as illustrated in FIG. 9, twelve pressure spaces S1 may be provided in the upper surface of the pressure jig 110. A plurality of through holes S2a and S2b may be provided in the top jig 120A. For example, the same number of through holes S2a and S2b as the pressure spaces S1 may be provided in the fixing plate 121A of the top jig 120A. At this time, the through holes S2a and S2b may be arranged to correspond to the pressure spaces S1, for example, the through holes S2a and S2b and the pressure spaces S1 may be arranged to face each other.

Meanwhile, at least a portion (e.g., the through holes S2a) of the plurality of through holes S2a and S2b may be formed to be different from the other through holes S2a in at least one of a size and a shape. For example, as illustrated in FIG. 9, five through holes S2b may be formed in the same shape and size, and the remaining through holes S2a may be formed in the same shape as the five through holes S2b but in the smaller size than the five through holes S2b.

The through holes S2a and S2b match the venting holes BH in the battery module 1000, and may be an important factor in simulating the venting gas behavior. For example, by changing the relative sizes of the through holes S2a and S2b, various types of venting gas behaviors may be simulated. Therefore, according to the configuration of the embodiment above, the venting pressure may be accurately measured under various conditions.

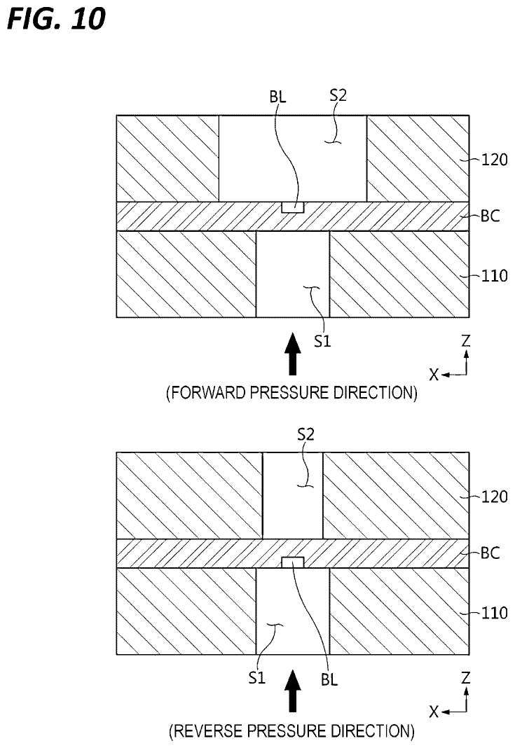

With respect to the size of the through hole S2, the venting gas behavior will be further described with reference to FIG. 10. FIG. 10 is a sectional view schematically illustrating two situations where the venting cover BC of the battery module 1000 ruptures.

Referring to FIG. 10, the venting in the battery module 1000 may be classified into two types. In the first type, thermal runaway occurs in the battery module 1000, and gas may be discharged from the inside of the battery module 1000 to the outside. For example, this direction may be a gas behavior direction that may occur in a typical thermal runaway situation, and is represented as a forward pressure direction in FIG. 10. In the second type, the venting cover BC ruptures in the direction from the outside toward the inside of the battery module 1000, due to the high-pressure gas generated from thermal runaway in adjacent battery modules 1000. This direction may be a gas behavior direction that occurs when the thermal runaway propagates between the battery modules 1000, and is represented as a reverse pressure direction in FIG. 10.

In the forward pressure direction, the gas may flow from the narrow complex space in the battery module 1000 to the open external space. Thus, as illustrated in FIG. 10, the through hole S2 through which pressure is discharged may be simulated to be larger than the pressure space S1 to which pressure is applied. In this case, the venting cover BC may be disposed such that the separation line BL faces the through hole S2. This may be because, when the venting cover BC is coupled to the battery module 1000, the separation line BL of the venting cover BC is disposed to face the upward direction, that is, to face the upper plate 1311 (see, e.g., FIG. 1).

In the reverse pressure direction, the gas may flow from the wide external space of the module case 1300 toward the narrow space, for example, toward the inside of the battery module 1000. In the reverse pressure direction, the pressure space S1 to which pressure is applied may match the external space of the module case 1300, and the through hole S2 may match the narrow space in the battery module 1000. Accordingly, as illustrated in FIG. 10, the through hole S2 may be simulated to have a size smaller than (or similar to) the pressure space S1. In this case, the venting cover BC may be disposed such that the separation line BL faces the pressure space S1. This is because pressure may be applied to the upper surface of the venting cover BC (e.g., the surface in which the separation line BL is formed) when the thermal runaway propagates in the actual battery modules 1000.

As described above, the venting gas behavior may differ in the forward pressure direction and the reverse pressure direction, and may be simulated by changing the relative sizes of the through hole S2 and the pressure space S1. Here, the reason for changing the size of the through hole S2 may be that it is easier to change the size of the through hole S2 formed in the top jig 120 in view of the structure of the venting pressure measuring apparatus 100.

According to the embodiment of the configuration above, the venting pressure may be measured while simulating different venting gas behaviors, for example, the behaviors in the forward pressure direction and the reverse pressure direction. At this time, since the through holes S2 having different sizes are formed in the top jig 120, the venting pressure in the two behaviors may be accurately measured through a single measurement test.

In order to measure the venting pressure in the forward pressure direction and the reverse pressure direction through a single measurement test, it may be advantageous for more accurate measurement of the venting pressure to form the separation line BL at different positions in the venting cover BC according to respective portions. For example, as illustrated in FIG. 10, in the portion disposed at the relatively large through hole S2, the separation line BL may be formed in the upper surface of the venting cover BC, and in the portion disposed at the relatively small through hole S2, the separation line BL may be formed in the lower surface of the venting cover BC.

Meanwhile, the venting pressure measuring apparatus 100 may further include the pressure generator 130 described above. Here, the pressure generator 130 may be a device that forms pressure in a specific space or region. For example, the pressure generator 130 may operate by compressing gas or liquid or injecting the same into a sealed space to increase the pressure. As an example, the pressure generator 130 may be implemented in the form of a compressor.

The pressure generator 130 may apply pressure to the plurality of pressure spaces S1 of the venting pressure measuring apparatus 100. For example, the pressure generator 130 may apply different pressures to the plurality of pressure spaces S 1 according to two or more respective portions. Hereinafter, descriptions will be continued referring back to FIG. 3.

The pressure generator 130 may be connected to the plurality of pressure spaces S1 via connection pipes 131. A valve 132 may be provided in each connection pipe 131. At this time, the connection pipes 131 connected to the plurality of pressure spaces S1 may be grouped, or the connection pipes 131 may be individually connected to the plurality of pressure spaces S1. Alternately, the valves 132 may be grouped or individually provided. Then, the pressure applied to the pressure spaces S1 in this way may be controlled individually or by groups. For example, when the connection pipe 131 and the valve 132 are individually installed in each pressure space S1, pressure may be individually applied to each pressure space S1 through the control of the valve 132.

According to the embodiment of the configuration above, the venting gas behavior may be more accurately simulated by changing the properties of the pressure (e.g., magnitude and increasing rate) applied to multiple portions of the venting cover BC in consideration of the thermal runaway situation in the battery module 1000.

Referring back to FIGS. 4 and 5, the venting pressure measuring apparatus 100 may further include a gasket 150. The gasket 150 may be provided for the sealing between the pressure jig 110 and the venting cover BC. For example, as illustrated in FIG. 4, the gasket 150 may be formed in a plate shape. According to an embodiment, openings S3 may be formed in the gasket 150 at positions corresponding to the pressure spaces S1. The gasket 150 may be disposed between the upper surface of the pressure jig 110 and the venting cover BC. The gasket 150 may seal the gap between the pressure jig 110 and the venting cover BC, for example, may prevent the pressure formed in the pressure spaces S1 from leaking into the gap between the upper surface of the pressure jig 110 and the venting cover BC. The gasket 150 may be made of various materials such as a non-metal material, a semi-metal material, a metal material, and graphite. For example, in consideration of the characteristics of the venting pressure measuring process, the gasket 150 may be made of a material capable of maintaining sealing performance and durability even under a high-temperature and high-pressure condition, such as a metal or graphite.

According to the configuration of the embodiment above, pressure may be efficiently applied to the venting cover BC. Further, since no pressure leaks, the pressure when the venting cover BC ruptures, that is, the venting pressure may be accurately measured.

Meanwhile, as illustrated in FIG. 3, the venting pressure measuring apparatus 100 may further include a control unit 160. The control unit 160 may measure the pressure when the venting cover BC ruptures. For example, the control unit 160 may specify a time point at which the venting cover BC ruptures. Then, the control unit 160 may identify the pressure applied to the pressure space S1 at the specified time point, and determine the identified pressure to be the venting pressure.

According to the embodiment of the configuration above, the pressure when the venting cover BC ruptures may be automatically measured. Accordingly, a user does not need to directly check the time point at which the venting cover BC ruptures and the pressure at the corresponding time point, and therefore, the pressure measuring process may be more easily and accurately performed.

The control unit 160 may determine the time point at which the venting cover BC ruptures, based on data for the pressure in the pressure space S1 of the venting pressure measuring apparatus 100. For example, the control unit 160 may include a pressure sensor. The pressure sensor may be provided in the pressure space S1 or in a space communicating with the pressure space S1, for example, the connection pipe 131. The pressure sensor may measure the pressure inside the pressure space S1. The control unit 160 may be electrically connected to the pressure sensor, and may receive pressure data measured by the pressure sensor in real time.

When pressure is applied to the pressure space S1, the pressure of the pressure space S1 may continuously increase. Then, at the time point when venting occurs, the compressed air in the pressure space S1 may be discharged to the outside, and accordingly, the pressure in the pressure space S1 may instantaneously drop. The control unit 160 may specify the moment at which the pressure drops in the received data as a venting time point. Then, the control unit 160 may determine the pressure at the venting time point (e.g., the pressure indicated in the pressure data) to be the venting pressure.

According to the configuration of the embodiment above, the venting time point may be accurately detected using the real-time pressure change in the pressure space S1, and the pressure at the venting time point may be determined to be the venting pressure. Therefore, the venting pressure may be accurately measured.

Meanwhile, the control unit 160 may measure the venting pressure of the venting cover BC twice. The size of the through hole S2 of the top jig 120 may differ in the two measurements. For example, as described above, the venting pressure of the venting cover BC in the forward pressure direction and the venting pressure of the venting cover BC in the reverse pressure direction may be different from each other. For example, the control unit 160 may measure the venting pressure in the forward pressure direction in the first measurement, and may measure the venting pressure in the reverse pressure direction in the second measurement. Here, the size of the through hole S2 of the top jig 120 used in the first venting pressure measurement in the forward pressure direction may be different from that in the second venting pressure measurement in the reverse pressure direction. For example, in the venting pressure measurement in the forward pressure direction, the through hole S2 may have a larger size than the pressure space S1. In the venting pressure measurement in the reverse pressure direction, the through hole S2 may have a smaller size than the pressure space S1.

Furthermore, the orientations of the surface of the venting cover BC in which the separation line BL is formed may differ in the first and second venting pressure measurement processes. In the first measurement, the surface in which the separation line BL is formed may be disposed to face the through hole S2. In the second measurement, the surface in which the separation line BL is formed may be disposed to face the pressure space S1. Since the reason for disposing the surface of the venting cover BC in this way has been described above with reference to FIG. 10, additional descriptions will be omitted.

Meanwhile, the control unit 160 may further include a temperature sensor that may measure the temperature of the venting cover BC. For example, the temperature sensor may be provided on the surface of the top jig or the pressure jig, and may measure the temperature of the venting cover BC at the corresponding position. The control unit 160 may be electrically connected to the pressure generator 130, the valves 132, the pressure sensor, the temperature sensor, and the heating unit 140, and may control them. The control unit 160 may control, for example, the pressure (e.g., magnitude and increasing rate) applied to the venting cover BC and the temperature of the venting cover BC, through the control of the pressure generator 130, the valves 132, and the heating unit 140. The control unit 160 may receive data measured by, for example, the pressure sensor and the temperature sensor in real time, and may determine and store overall conditions when the venting cover BC ruptures. Here, the overall conditions may refer to the pressure and the temperature when the venting cover BC ruptures (pressure and temperature data for each pressure space may be checked).

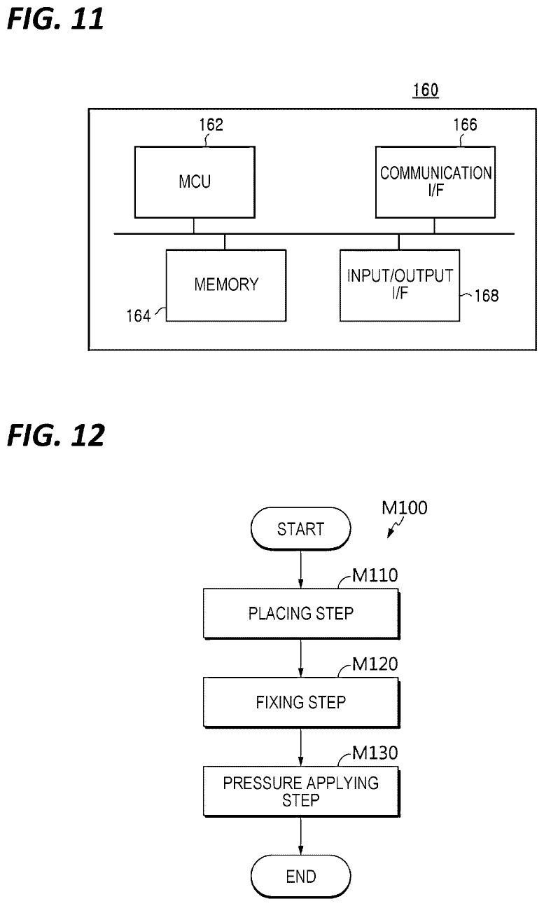

FIG. 11 is a block diagram illustrating a hardware configuration for implementing the control unit 160 included in the venting pressure measuring apparatus 100 according to an embodiment of the present disclosure.

The control unit 160 according to an embodiment of the present disclosure may include an MCU 162, a memory 164, a communication I/F 166, and an input/output I/F 168. The MCU 162 is a micro controller unit, which is a processor that executes various programs stored in the memory 164 and processes various data used for the programs to perform the functions of the control unit 160.

The memory 164 may store operation data of various programs related to the operation of a lithium secondary battery system for the operation of the control unit 160. A plurality of memories 164 may be provided as needed. The memory 164 may be a volatile memory or a nonvolatile memory. As the volatile memory, the memory 164 may be, for example, a RAM, a DRAM, or a SRAM. As the nonvolatile memory, the memory 164 may be, for example, a ROM, a PROM, an EAROM, an EPROM, an EEPROM, or a flash memory. The examples of the memory 164 above are merely illustrative and are not limited thereto.

The communication I/F 166 may be a component that may transmit and receive various types of data to/from a server, and may be any device capable of supporting wired or wireless communication. For example, through the communication I/F 166, programs or various types of data for the operation of the control unit 160 may be transmitted and received to/from an external server provided separately, by a wired or wireless method. The input/output I/F 168 may provide an interface that connects input devices (not illustrated) such as a keyboard, a mouse, and a touch panel and output devices (not illustrated) such as a display to the MCU 162, to enable data transmission and reception.

Hereinafter, a venting pressure measuring method according to an embodiment of the present disclosure will be described. The descriptions will be made with reference to the configuration of the venting pressure measuring apparatus 100 described above. The overlapping descriptions of the venting pressure measuring apparatus 100 will be omitted or briefly summarized.

FIG. 12 is a schematic flowchart illustrating the venting pressure measuring method according to an embodiment of the present disclosure. A venting pressure measuring method M100 according to the present embodiment may be a method for measuring the venting pressure of the venting cover BC provided in the battery module 1000. Referring to FIGS. 12 and 4, the venting pressure measuring method M100 according to the present embodiment may include a placing step M110, a fixing step M120, and a pressure applying step M130.

In the placing step M110, the venting cover BC may be placed on the pressure jig 110 of the venting pressure measuring apparatus 100. At this time, the pressure space S1 may be provided in the pressure jig 110. For example, the pressure space S1 may be provided in the upper surface of the pressure jig 110. Then, the pressure space S1 may be connected to the pressure generator 130. The venting cover BC may be placed and supported on the upper surface of the pressure jig 110.

In the fixing step M120, the venting cover BC of the venting pressure measuring apparatus 100 may be pressed into close contact with the pressure jig 110. For example, the top jig 120 may be placed on the venting cover BC. The top jig 120 may press the venting cover BC downward (in the Z-axis direction), and consequently, the venting cover BC may come into close contact with and fixed to the upper surface of the pressure jig 110. The through hole S2 may be formed in the top jig 120.

In the pressure applying step M130, pressure may be applied to the venting cover BC through the pressure space S1 of the pressure jig 110. For example, when the pressure generator 130 generates pressure in the pressure space S1, the generated pressure may be applied to the venting cover BC. When the applied pressure exceeds a specific pressure, for example, the venting pressure, the venting cover BC may rupture. At this time, by measuring the pressure when the venting cover BC ruptures, the venting pressure may be obtained.

According to the configuration of the embodiment above, while actually applying pressure to the venting cover BC, the pressure at which the venting cover BC ruptures may be measured as the venting pressure. Therefore, the venting pressure may be more accurately and rapidly measured. In the configuration of the present embodiment, by reflecting the coupling structure of the venting cover BC in the battery module 1000, the venting gas behavior in the actual battery module 1000 may be simulated, and therefore, the venting pressure may be accurately measured.

The placing step M110, the fixing step M120, and the pressure applying step M130 may be sequentially repeated twice. The two fixing steps M120 may be performed using top jigs 120 different from each other in at least one of the size and shape of the through hole S2.

For example, as described above, the venting pressure at which the venting cover BC ruptures may differ between the forward pressure direction and the reverse pressure direction. Accordingly, in order to measure the venting pressure in both the forward pressure direction and the reverse pressure direction, the placing step M110, the fixing step M120, and the pressure applying step M130 may be performed twice.

For example, when the venting pressure in the forward pressure direction is measured, the venting cover BC may be placed on the pressure jig 110 (M110). Then, the venting cover BC may be pressed into close contact with and fixed to the pressure jig 110 using the top jig 120 (M120). Thereafter, while applying pressure to the pressure space S1, the pressure at which the venting cover BC ruptures is measured, so that the venting pressure in the forward pressure direction may be measured (M130).

Then, the process above may be repeated. For example, a new venting cover BC may be placed on the pressure jig 110 (M110). Then, the venting cover BC may be pressed into close contact with and fixed to the pressure jig 110 using the top jig 120 (M120). At this time, the venting cover BC may be fixed using the top jig 120 with the through hole S2 in a different size. Then, the venting pressure in the reverse pressure direction may be measured by applying pressure to the pressure space S1 (M130).

According to the configuration of the embodiment above, the venting pressure of the venting cover BC in both the forward pressure direction and the reverse pressure direction may be measured. In this case, considering that the venting gas behavior differs between the forward pressure direction and the reverse pressure direction, the venting pressure may be more accurately measured by changing the size of the through hole S2.

Of the two fixing steps M120, one fixing step M120 may be performed using the top jig 120 in which the through hole S2 is formed to be larger than the pressure space S1, and the other fixing step M120 may be performed using the top jig 120 in which the through hole S2 is formed in a size smaller than or equal to the pressure space S1.

For example, as described above with reference to FIG. 10, the configuration where the size of the through hole S2 differs in the forward pressure direction and the reverse pressure direction may be more suitable for the venting gas flow. Accordingly, in one fixing step, for example, in the venting pressure measuring process in the forward pressure direction, the venting cover BC may be pressed into close contact with and fixed to the pressure jig 110 using the top jig 120 in which the size of the through hole S2 is larger than that of the pressure space S1. In the other fixing step, for example, in the venting pressure measuring process in the reverse pressure direction, the venting cover BC may be pressed into close contact with and fixed to the pressure jig 101 using the top jig 120 in which the size of the through hole S2 is smaller than (or equal to) the pressure space S1.

According to the configuration of the embodiment above, the venting gas behavior in both the forward pressure direction and the reverse pressure direction may be more accurately simulated. Therefore, the venting pressure in the forward pressure direction and the reverse pressure direction may be more accurately measured.

Meanwhile, the separation line BL may be provided in one surface of the venting cover BC. For example, the separation line BL may be provided in the upper surface of the venting cover BC, and this configuration has been described above.

Of the two fixing steps M120, one fixing step M120 may be performed in the state where the surface of the venting cover BC in which the separation line BL is formed faces the through hole S2. The other fixing step M120 may be performed in the state where the surface in which the separation line BL is formed faces the pressure space S1.

For example, one fixing step above may be the venting pressure measuring process in the forward pressure direction. In this process, the surface in which the separation line BL is formed may be disposed to face upward, for example, to face the through hole S2. This has been described above with reference to FIG. 10.

The other fixing step M120 may be the venting pressure measuring process in the reverse pressure direction. In this process, the surface in which the separation line BL is formed may be disposed to face downward, that is, to facc the pressure space S1.

According to the configuration of the embodiment above, not only the venting gas behavior in the forward pressure direction and the reverse pressure direction, but also the orientation of the separation line BL of the venting cover BC may be more accurately simulated. Therefore, the venting pressure in the forward pressure direction and the reverse pressure direction may be more accurately measured.

The through hole S2 may be formed to correspond to the shape of the venting hole BH. For example, the venting hole BH may be formed in the battery module 1000. The venting hole BH is provided to discharge gas and flame to the outside when thermal runaway occurs, and may be formed in the upper plate of the module case 1300. The through hole S2 may be formed in a shape corresponding to the shape of the venting hole BH. In simulating the venting gas behavior, the through hole S2 matches the venting hole BH, and this configuration has been described above.

According to the configuration of the embodiment above, the venting gas behavior may be more accurately simulated. Therefore, the venting pressure may be more accurately measured.

The pressure space S1 of the pressure jig 110 and the through hole S2 of the top jig 120 may be provided in plural. A plurality of through holes S2 may be formed at positions corresponding to a plurality of pressure spaces S1. For example, a plurality of pressure spaces S1 may be provided in the pressure jig 110. As illustrated in FIG. 8, for example, twelve pressure spaces S1 may be provided in the upper surface of the pressure jig 110. A plurality of through holes S2 may be formed in the top jig 120. For example, the same number of through holes S2a and S2b as the number of pressure spaces S1 may be provided in the fixing plate of the top jig 120. At this time, the through holes S2a and S2b may be arranged to correspond to the pressure spaces S1, and for example, the through holes S2a and S2b and the pressure spaces S1 may be arranged to face each other.

Meanwhile, at least a portion of the plurality of through holes S2a and S2b may be formed to be different from the other through holes S2 in at least one of size and shape. For example, as illustrated in FIG. 9, five through holes S2b may be formed to be larger than the other through holes S2a.

The through holes S2a and S2b match the venting holes BH in the battery module 1000, and may be an important factor in simulating the venting gas behavior. For example, by changing the size of the through holes S2a and S2b, different types of gas venting behaviors may be simulated. Therefore, the venting pressure under more various conditions may be accurately measured.

With the configuration described above, the venting pressure in the forward pressure direction and the reverse pressure direction may be measured at once. For example, at the position where the size of the through hole S2b is larger than the pressure space S1, the venting gas behavior in the forward pressure direction may be simulated. At the position where the size of the through hole S2a is smaller than the pressure space S1, the venting gas behavior in the reverse pressure direction may be simulated. Accordingly, at the portion disposed below the large through hole S2b, the separation line BL is formed in the upper surface of the venting cover BC, and at the portion disposed below the small through hole S2a, the separation line BL is formed in the lower surface of the venting cover BC. Then, by performing the venting pressure measuring method described above using the venting cover BC, the venting pressure in the forward pressure direction and the reverse pressure direction may be accurately measured at once.

The pressure applied to at least one of the plurality of pressure spaces S1 may be controlled differently from the pressure applied to the remaining pressure spaces S1. Specifically, the pressure spaces S1 may be connected to the pressure generator 130, and the connection pipes 131 connected to the plurality of pressure spaces S1 may be grouped or individually connected. In this way, the pressure applied to the pressure spaces S1 may be controlled individually or by groups.

According to the embodiment of the configuration above, by changing the properties of the pressure (e.g., magnitude and increasing rage) applied to multiple portions of the venting cover BC in consideration of the thermal runaway situation occurring in the battery module 1000, the venting gas behavior may be more accurately simulated.

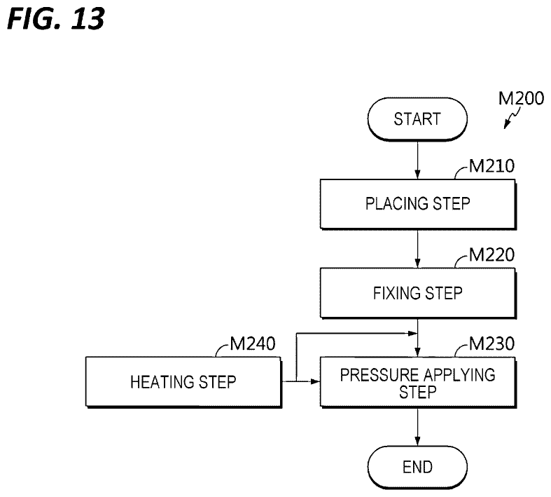

FIG. 13 is a schematic flowchart illustrating a venting pressure measuring method according to another embodiment of the present disclosure. Referring to FIG. 13, a venting pressure measuring method M200 according to the present embodiment may include a placing step M210, a fixing step M220, a pressure applying step M230, and a heating step M240. Of the steps, the placing step M210, the fixing step M220, and the pressure applying step M230 are substantially the same as or similar to those described above, and thus, descriptions thereof will be omitted.

The heating step M240 is a step of heating the venting cover BC, and may be performed by the heating unit described above. The heating step M240 may be performed prior to the pressure applying step M230. For example, after the venting cover BC is fixed to the pressure jig 110, the venting cover BC may be heated to a temperature similar to the temperature in the thermal runaway situation. Then, pressure may be applied to the venting cover BC to measure the venting pressure.

Alternatively, after the venting cover BC is fixed to the pressure jig 110, the heating of the venting cover BC may be initiated and may be continuously performed while pressure is being applied to the venting cover BC. This process may be similar to the actual thermal runaway situation, considering that the venting cover BC is continuously heated in the actual thermal runaway situation.

According to the configuration of the embodiment above, the venting pressure may be measured in the state where the venting cover BC is heated to a high temperature, which is similar to the actual thermal runaway state.

While embodiments of the present disclosure have been described with reference to the drawings, the present disclosure is not limited to the embodiments, and various modifications may be made by those skilled in the art of the present disclosure without departing from the technical gist of the present disclosure set forth in the claims. The modifications should not be interpreted independently from the technical idea or scope of the present disclosure.

What is claimed is:

1. A venting pressure measuring apparatus comprising:
a pressure jig configured to allow a venting cover of a battery module to be placed and supported thereon, and provided with a pressure space formed to apply pressure to the venting cover; and
a top jig configured to press the venting cover into close contact with the pressure jig, and provided with a through hole formed at a position corresponding to the pressure space,
wherein a gas flow when venting occurs in the battery module is simulated by shapes of the pressure space and the through hole thereby allowing a pressure at which the venting cover ruptures to be measured.

2. The venting pressure measuring apparatus according to claim 1, further comprising:
a heater configured to heat the venting cover.

3. The venting pressure measuring apparatus according to claim 2, wherein the heater includes a heat generation member that is embedded in the pressure jig.

4. The venting pressure measuring apparatus according to claim 2, wherein the pressure applied to the venting cover is formed by gas supplied to the pressure space, and
the heater is configured to heat the gas supplied to the pressure space.

5. The venting pressure measuring apparatus according to claim 1, wherein the pressure space is formed in a shape corresponding to a shape of the through hole.

6. The venting pressure measuring apparatus according to claim 1, wherein a plurality of pressure spaces is provided in the pressure jig, and
a plurality of through holes is provided in the top jig at positions corresponding to the plurality of pressure spaces.

7. The venting pressure measuring apparatus according to claim 6, wherein at least portion of the plurality of through holes is formed to be different from remaining through holes in at least one of a size and a shape.

8. The venting pressure measuring apparatus according to claim 6, further comprising:
a pressure generator configured to apply pressure to the plurality of pressure spaces,
wherein different pressures are applied to the plurality of pressure spaces according to at least two or more respective portions.

9. The venting pressure measuring apparatus according to claim 1, further comprising:
a controller configured to measure the pressure when the venting cover ruptures due to the pressure applied by the pressure space.

10. The venting pressure measuring apparatus according to claim 9, wherein the controller includes a pressure sensor that measures pressure in the pressure space, and determines a time point when the venting cover ruptures, based on data of the pressure measured by the pressure sensor.

11. The venting pressure measuring apparatus according to claim 9, wherein the controller measures the pressure when the venting cover ruptures, twice, and a size of the through hole in a first measurement and a size of the through hole in a second measurement are different from each other.

12. A venting pressure measuring method for measuring a venting pressure of a venting cover used as a component of a battery module, the venting pressure measuring method comprising:
a placing step of placing the venting cover in a pressure jig provided with a pressure space;
a fixing step of pressing the venting cover using a top jig provided with a through hole formed at a position corresponding to the pressure space, thereby bringing the venting cover into close contact with the pressure jig; and
a pressure applying step of applying pressure to the venting cover through the pressure space.

13. The venting pressure measuring method according to claim 12, wherein the placing step, the fixing step, and the pressure applying step are sequentially repeated twice, and
two fixing steps are performed using top jigs different from each other in at least one of a size and a shape of the through hole.

14. The venting pressure measuring method according to claim 13, wherein, of the two fixing steps, one fixing step is performed using a top jig provided with a through hole larger than the pressure space, and a remaining fixing step is performed using a top jig provided with a through hole equal to or smaller than the pressure space.

15. The venting pressure measuring method according to claim 14, wherein a separation line, which is configured to easily rupture, is formed in one surface of the venting cover,
the one fixing step is performed in a state where the surface in which the separation line is formed is disposed to face the through hole, and
the remaining fixing step is performed in a state where the surface in which separation line is formed is disposed to face the pressure space.

16. The venting pressure measuring method according to claim 12, wherein a plurality of pressure spaces is provided in the pressure jig,
a plurality of through holes is provided in the top jig at positions corresponding to the plurality of pressure spaces, and
at least a portion of the plurality of through holes is formed to be different fr remaining through holes in at least one of a size and a shape.

17. The venting pressure measuring method according to claim 16, wherein pressure applied to at least a portion of the plurality of pressure spaces is controlled differently from pressure applied to remaining pressure spaces.

18. The venting pressure measuring method according to claim 12, further comprising:
a heating step of heating the venting cover,
wherein the heating step is performed prior to or simultaneously with the pressure applying step.
